(19) United States
(12) Patent Application Publication
(10) Pub. No.: US 2021/0278464 A1
(43) Pub. Date: Sep. 9, 2021

(54) CONDITION ASSESSMENT METHOD AND DEVICE FOR AN OUTDOOR POST-MOUNTED VACUUM SWITCH

(71) Applicants: STATE GRID JIANGXI ELECTRIC POWER COMPANY LIMITED RESEARCH INSTITUTE, Jiangxi (CN); STATE GRID CORPORATION OF CHINA; NANCHANG KECHENG ELECTRIC POWER AND RESEARCH CO., LTD., Jiangxi (CN)

(72) Inventors: Ning Xu, Jiangxi (CN); Jianbing Pan, Jiangxi (CN); Ruixiang Fan, Jiangxi (CN); Zaide Xu, Jiangxi (CN); Bei Cao, Jiangxi (CN); Yang Liu, Jiangxi (CN); Yuan Xu, Jiangxi (CN); Hongxia Xiao, Jiangxi (CN)

(73) Assignees: STATE GRID JIANGXI ELECTRIC POWER COMPANY LIMITED RESEARCH INSTITUTE, Jiangxi (CN); STATE GRID CORPORATION OF CHINA, Beijing (CN); NANCHANG KECHENG ELECTRIC POWER TEST AND RESEARCH CO., LTD., Jiangxi (CN)

(21) Appl. No.: 16/497,644

(22) PCT Filed: Dec. 11, 2018
(86) PCT No.: PCT/CN2018/120228

§ 371 Date: Sep. 25, 2019

(30) Foreign Application Priority Data
Jan. 23, 2018 (CN) 201810064359.3

(51) Int. Cl. G01R 31/327; G06F 30/367

(52) U.S. Cl. CPC G01R 31/3275; G06F 2119/06; G06F 30/367

(57) ABSTRACT

Disclosed is a condition assessment method for an outdoor post-mounted vacuum switch. The method includes: establishing a condition assessment mathematical model for the post-mounted vacuum switch and acquiring scores of condition indicators of the post-mounted vacuum switch; and acquiring a condition assessment score based on the condition assessment mathematical model of the post-mounted vacuum switch and according to the scores of the condition indicators of the post-mounted vacuum switch so as to realize on-line monitoring of a health condition of the post-mounted vacuum switch and assess the health condition of the post-mounted vacuum switch. Further disclosed is a condition assessment device for the outdoor post-mounted vacuum switch.

The present application claims the priority of Chinese patent application No. 201810064359.3 filed on Jan. 23, 2018, which is incorporated in the present application by reference in its entirety.

### TECHNICAL FIELD

The present disclosure relates to the field of power switch technology, and for example, to a condition assessment method and device for an outdoor post-mounted vacuum switch.

### BACKGROUND

Along with the social and economic development and the continuous improvement of people's living standard, the demands of users on the power supply reliability are higher and higher. In traditional planned maintenance or preventive maintenance, it needs to carry out power outage of the grid region by region for electric equipment maintenance, which can cause greater waste and increased maintenance costs. A condition indicator assessment method for a 10 kV post-mounted vacuum switch is proposed in “Regulation of condition based maintenance test for electric distribution network equipment” (Q/GDW 643-2011), “Guidelines of condition based maintenance for electric distribution network equipment” (Q/GDW 644-2011), and “Guidelines of condition assessment for electric distribution network equipment” (Q/GDW 645-2011). The condition indicator is a general term of parameters that directly or indirectly characterize the condition of the equipment such as various technical indicators, performances, running conditions and the like, and is used for reflecting the technical performances of equipment. When the condition indicator changes, the change degree of the condition indicator is quantified, and the change degree of the corresponding performance or the running condition of the equipment can be known. According to the influence degree of the condition indicator itself on the safe running of the equipment, the corresponding maintenance strategy is made. However, the method mainly relies on routine inspection, energized test, routine test and other data for periodic assessment or dynamic assessment. Since the routine test and the routine inspection need a long time, the difficulty in obtaining condition indicators will delay the determine the equipment health state.

### SUMMARY

The disclosure provides a condition assessment method and device of an outdoor post-mounted vacuum switch to control the health condition of the outdoor post-mounted vacuum switch, to discover defects or hidden dangers in time and to avoid equipment damage, personal electric shock and casualties, user power failure, and the like.

An embodiment provides a condition assessment method for an outdoor post-mounted vacuum switch, and the method includes:

establishing a condition assessment mathematical model for the post-mounted vacuum switch, and obtaining score of condition indicators of the post-mounted vacuum switch; and

acquiring a condition assessment score based on the condition assessment mathematical model of the post-mounted vacuum switch and according to the scores of condition indicators of the post-mounted vacuum switch, so as to realize on-line monitoring of a health condition of the post-mounted vacuum switch and assess the health condition of the post-mounted vacuum switch.

The condition assessment mathematical model of the post-mounted vacuum switch is configured as follows:

$$M = {M}_{0} - {\sum }_{i = 1}^{10} {M}_{i} .$$

M denotes the condition assessment score. Mᵢ denotes the score of the ith condition indicator of the post-mounted vacuum switch, and M₀=100K_{T}X_{f}. X_{f} denotes a repair coefficient, and a lifetime coefficient K_{T}=(100−0.5Y)/100. Y denotes a service life.

An embodiment provides a condition assessment device for an outdoor post-mounted vacuum switch, and the device includes:

a model establishment module, configured to establish a condition assessment mathematical model for the post-mounted vacuum switch, and obtain scores of condition indicators of the post-mounted vacuum switch; and a condition assessment module, configured to acquire a condition assessment score based on the condition assessment mathematical model of the post-mounted vacuum switch according to the scores of the condition indicators of the post-mounted vacuum switch, so as to realize on-line monitoring of a health condition of the post-mounted vacuum switch and assess the health condition of the post-mounted vacuum switch.

The condition assessment mathematical model of the post-mounted vacuum switch is configured as follows:

$$M = {M}_{0} - {\sum }_{i = 1}^{10} {M}_{i}$$

M denotes the condition assessment score. Mᵢ denotes the score of the ith condition indicator of the post-mounted vacuum switch, and M₀=100 K_{T}X_{f}. X_{f} denotes a repair coefficient, and a lifetime coefficient K_{T}=(100−0.5Y)/100. Y denotes a service life.

### BRIEF DESCRIPTION OF DRAWINGS

FIG. 1 is a flowchart of a condition assessment method for an outdoor post-mounted vacuum switch according to an embodiment of the present disclosure;

FIG. 2 is a schematic diagram of another condition assessment method for the outdoor post-mounted vacuum switch according to an embodiment of the present disclosure;

FIG. 3 is a structural schematic diagram of a condition assessment device for the outdoor post-mounted vacuum switch according to an embodiment of the present disclosure; and

FIG. 4 is a flowchart of still another condition assessment method for the outdoor post-mounted vacuum switch according to an embodiment of the present disclosure.

### DETAILED DESCRIPTION

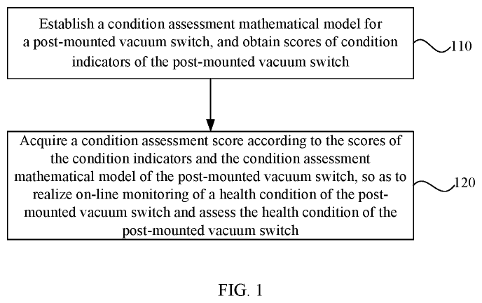

The present embodiment provides a condition assessment method for an outdoor post-mounted vacuum switch. FIG. 1 is a flowchart of the condition assessment method for the outdoor post-mounted switch provided by the embodiment of the present disclosure. As shown in FIG. 1, the method includes the following steps.

In step 110, a condition assessment mathematical model is established for the post-mounted vacuum switch, and scores of condition indicators of the post-mounted vacuum switch are obtained.

In step 120, a condition assessment score is acquired based on the condition assessment mathematical model of the post-mounted vacuum switch and according to the scores of the condition indicators of the post-mounted vacuum switch, so as to realize on-line monitoring of a health condition of the post-mounted vacuum switch and assess the health condition of the post-mounted vacuum switch.

The condition assessment mathematical model of the on-column vacuum switch is configured as follows:

$$M = {M}_{0} - {\sum }_{i = 1}^{10} {M}_{i}$$

M denotes the condition assessment score. Mᵢ denotes the score of the ith condition indicator of the post-mounted vacuum switch, and M₀=100 K_{T}X_{f}. X_{f} denotes a repair coefficient, and a lifetime coefficient K_{T}=(100−0.5Y)/100. Y denotes a service life.

In an embodiment, the outdoor post-mounted vacuum switch can be understood as a 35 kV post-mounted vacuum switch mounted or a post-mounted vacuum switch below 35 kV, for example, a 10 kV post-mounted vacuum switch.

In an embodiment, the post-mounted vacuum switch is an outdoor post-mounted vacuum switch.

The condition assessment method for the outdoor post-mounted vacuum switch provided by the embodiment of the present disclosure constructs a condition assessment mathematical model for the post-mounted vacuum switch by combining a plurality of condition indicators of the post-mounted vacuum switch to realize on-line monitoring and condition assessment of the health condition of the post-mounted vacuum switch.

In an embodiment, the condition indicators of the post-mounted vacuum switch includes at least one of: a condition indicator of a lightning parameter, a temperature condition indicator of a Feeder Terminal Unit (FTU) battery, a communication condition indicator, a condition indicator of a transformer, a voltage condition indicator of the FTU battery, a switch opening and closing condition indicator, a switch opening time condition indicator, an on-off characteristic condition indicator, a switch refuse operation condition indicator, or a switch maloperation condition indicator.

In an embodiment, the condition indicators of the post-mounted vacuum switch include the condition indicator of the lightning parameter.

The obtaining the scores of the condition indicators of the post-mounted vacuum switch includes:

collecting an amplitude I of a lightning current at a tower, a distance S between a lightning strike point and the tower, and a height h_{c} of the tower of the post-mounted vacuum switch through lightning location, and calculating a direct lightning stroke

$${U}_{0} = 25 I \frac{{h}_{c}}{S}$$

or a lightning induced overvoltage

$${U}_{0} = 25 I [ \frac{{h}_{c}}{S} + \sqrt{{( \frac{{h}_{c}}{S} )}^{2} + 1} ] ;$$

and

analyzing the value of U₀ according to a first preset analysis rule to obtain the score of the condition indicator of the lightning parameter.

The first preset analysis rule is as follows. A weight is a first preset value. When the U₀ is less than or equal to 85 kV, the score of the condition indicator of the lightning parameter is the first preset value. When the U₀ is greater than 85 kV and less than 140 kV or when the U₀ is equal to 140 kV, the score of the condition indicator of the lightning parameter is a first score value, where the first score value is less than the first preset value. When the U₀ is greater than 140 kV, the score of the condition indicator of the lightning parameter is obtained by reducing the first score value by a first preset deduction value every increment 1 kV of the U₀ on the basis of 140 kV.

That is, in an embodiment, a scoring method of the condition indicator of the lightning parameter is as follows.

An amplitude I of the lightning current at the tower, a distance S between a lightning strike point and the tower, and a height h_{c} of the tower of the post-mounted vacuum switch are collected through lightning locating, and a direct lightning stroke

$${U}_{0} = 25 I \frac{{h}_{c}}{S}$$

or a lightning induced overvoltage

$${U}_{0} = 25 I [ \frac{{h}_{c}}{S} + \sqrt{{( \frac{{h}_{c}}{S} )}^{2} + 1} ]$$

are calculated. The weight is 10 points. Analyzing is performed according to the overvoltage value: (1) U₀≤85 kV, 10 points; (2) 85<U₀≤140 kV, 8 points; (3) U₀>140 kV, for each increment 1 kV of the U₀ on the basis of 140 kV, the condition indicator is obtained by reducing the 8 points by 0.1 point, the reducing is ended when the 8 points is reduced to 0; and the condition indicator of the lightning parameter finally is M1.

In an embodiment, the values 85 kV, 140 kV, etc. are not fixed but determined depending on the actual application. For example, the described above condition may be set for the 10 kV post-mounted vacuum switch, and the described above condition may not be set for the 35 kV post-mounted vacuum switch. Similar situations exist below and are not described again.

In an embodiment, the condition indicators of the post-mounted vacuum switch include the temperature condition indicator of the FTU battery.

The process of obtaining the scores of the condition indicators of the post-mounted vacuum switch includes the following steps.

An internal temperature value of the FTU battery is collected in real time.

The internal temperature value of the FTU battery is analyzed according to a second preset analysis rule to obtain the score of the temperature condition indicator of the FTU battery.

The second preset analysis rule is as follows. A weight is a second preset value. When the internal temperature value of the FTU battery is greater than −25.0° C. and smaller than 55.0° C., the score of the temperature condition indicator of the FTU battery is the second preset value. When the internal temperature value of the FTU battery is greater than 55.1° C. and less than 64.9° C. or when the internal temperature value of the FTU battery is greater than −34.9° C. and less than −25.1° C., the score of the temperature condition indicator of the FTU battery is a second score value. When the internal temperature value of the FTU battery is greater than 65° C. and less than 69.999° C. or when the internal temperature value of the FTU battery is greater than −39.9° C. and less than −35.1° C., the score of the temperature condition indicator of the FTU battery is a third score value. When the internal temperature value of the FTU battery is greater than or equal to 70° C. or when the internal temperature value of the FTU battery is less than or equal to −40° C., the score of the temperature condition indicator of the FTU battery is zero. The second score value is less than the second preset value, and the third score value is less than the second score value.

That is, in an embodiment, the scoring method for the temperature condition indicator of the FTU battery is as follows.

The internal temperature of the FTU battery is collected in real time. The weight is be 5 points. The analyzing is performed according to the actual condition: (1) −25.0° C. to 55.0° C., 5 points; (2) 55.1° C. to 64.9° C. or −25.1° C. to −34.9° C., 3 points; (3) 65° C. to 69.999° C. or −35.1° C. to −39.9° C., 2 points; (4) greater than 70° C. or below −40° C., 0 point. The final score of the temperature condition indicator of the FTU battery is M2.

In an embodiment, the condition indicators of the post-mounted vacuum switch include the communication condition indicator.

The process of obtaining the scores of the condition indicators of the post-mounted vacuum switch includes the following steps.

The communication condition of the vacuum switch is determined according to the equipment time and the time of the post-mounted vacuum switch is acquired.

The time is analyzed according to a fourth preset analysis rule to obtain the score of the communication condition indicator.

The fourth preset analysis rule is as follows. The weight is a fourth preset value. When an absolute value of a difference between a time of a server and the time of the post-mounted vacuum switch is less than a preset time threshold value, it is confirmed that the post-mounted vacuum switch is in normal communication, and the score of the communication condition indicator is the fourth preset value. When the absolute value of the difference between the time of the server and the time of the post-mounted vacuum switch is not less than the preset time threshold value, it is confirmed that the post-mounted vacuum switch is in abnormal communication, and the score of the communication condition indicator is 0.

That is, in an embodiment, a scoring method for the communication condition indicator is as follows.

The communication state of the post-mounted vacuum switch is determined according to the time, and the weight is 5 points. When the absolute value of the difference between the current server time and the time (equipment time) of the post-mounted vacuum switch is within 15 minutes, it is indicated that the post-mounted vacuum switch is in normal communication. When the absolute value of the difference between the current server time and the time (equipment time) of the post-mounted vacuum switch is beyond 15 minutes, it is indicated the post-mounted vacuum switch is in abnormal communication. When the vacuum switch is in the normal condition, the score is 5 points. When the vacuum switch is in the abnormal condition, no score. The final score of the communication condition indicator is M3.

In an embodiment, the condition indicators of the post-mounted vacuum switch include the condition indicator of the transformer, and the process of obtaining the scores of the condition indicators of the post-mounted vacuum switch includes the following steps.

A voltage value and a three-phase unbalance factor of a current are acquired;

The voltage value and the three-phase unbalance factor of the current are respectively analyzed according to a fifth preset analysis rule to obtain the score of the condition indicator of the transformer.

The fifth preset analysis rule is as follows. When the three-phase unbalance factor of the current is less than a preset percentage, a first part score of the condition indicator of the transformer is a fourth score value. When the three-phase unbalance factor of the current is not less than the preset percentage, the first part score of the condition indicator of the transformer is 0. In the case of not being grounded, when the voltage value is greater than 5.5 kV and less than 6.5 kV or when the voltage value is equal to 5.5 kV or when the voltage value is equal to 6.5 kV, a second part score of the condition indicator of the transformer is the fourth score value. In the case of not being grounded, when the voltage value is less than 5.5 kV or greater than 6.5 kV, the second part score of the condition indicator of the transformer is 0. The score of the condition indicator of the transformer is a sum of the first part score of the condition indicator of the transformer and the second part score of the condition indicator of the transformer.

That is, in an embodiment, a scoring method for the condition indicator of the transformer is as follows.

The transformer measurement is evaluated according to whether the current and the voltage are normal or not. The measurement of the transformer is normal when the three-phase unbalance factor of the current is less than 10 percent, the voltage is between 5.5 and 6.5 kV, and the transformer is not grounded. The measurement of the transformer is abnormal when the three-phase unbalance factor of the current is greater than or equal to 10 percent or when the transformer is not grounded and the voltage is not between 5.5 and 6.5 kV. The weight of the transformer measurement is 6 points, and the current and the voltage respectively account for 3 points. In a normal condition, the score is 3 points. In an abnormal condition, the score is 0. The final score of the condition indicator of the transformer is M4.

In an embodiment, the condition indicators of the post-mounted vacuum switch include the switch opening and closing condition indicator.

The process of obtaining the scores of the condition indicators of the post-mounted vacuum switch includes the following steps.

It is determined whether the post-mounted vacuum switch is in an opening state or a closing state, and a current value in the opening state or the closing state is acquired.

Analyzing is performed according to a sixth preset analysis rule in conjunction with the opening state of the post-mounted vacuum switch or the closing state of the post-mounted vacuum switch and the current value to obtain the score of the switch opening and closing condition indicator.

The sixth preset analysis rule is as follows. A weight is a fifth preset value. When the post-mounted vacuum switch is in the opening state and the current value is less than 3A, the score of the switch opening and closing condition indicator is the fifth preset value. When the post-mounted vacuum switch is in the opening state and the current value is not less than 3A, the score of the switch opening and closing condition indicator is 0. When the post-mounted vacuum switch is in the closing state and the current value is greater than 3A, the score of the switch opening and closing condition indicator is the fifth preset value. When the post-mounted vacuum switch is in the closing state and the current value is not greater than 3A, the score of the switch opening and closing condition indicator is 0.

That is, in an embodiment, a scoring method for the switch opening and closing condition indicator is as follows.

It is determined whether the vacuum switch is in the opening state or the closing state. If the vacuum switch is in the opening state, when the current value is less than 3A, the vacuum switch is in a normal condition, and when the current value is greater than or equal to 3A, the vacuum switch is in an abnormal condition. If the vacuum switch is in the closing state, when the current value is greater than 3A, the vacuum switch is in the normal condition, and when the current value is less than or equal to 3A, the vacuum switch is in the abnormal condition. The weight of the opening/closing state is 4 points. When the vacuum switch is in the normal conditions, the score is 4 points, and when the vacuum switch is in the abnormal condition, the score is 0. The opening and closing condition indicator is M5.

In an embodiment, the condition indicators of the post-mounted vacuum switch include the voltage condition indicator of the FTU battery.

The process of obtaining the scores of the condition indicators of the post-mounted vacuum switch includes the following steps.

A real voltage U_{bat} of the FTU battery is acquired.

The value of U_{bat} is analyzed according to a third preset analysis rule to obtain the score of the voltage condition indicator of the FTU battery.

The third preset analysis rule is as follows. The weight is a third preset value. When the U_{bat} is greater than or equal to 26V, the score of the voltage condition indicator of the FTU battery is the third preset value. When the U_{bat} is less than 21V, the score of the voltage condition indicator of the FTU battery is 0. When the U_{bat} is greater than 21 V and less than 26V or when the U_{bat} is equal to 21V, the score of the voltage condition indicator of the FTU battery is acquired by reducing the third preset value by a second preset deduction value every decrement 1V of the U_{bat} on the basis of the third preset value.

That is, in an embodiment, the scoring method for the voltage condition indicator of the FTU battery is as follows.

Evaluating is performed according to a real voltage U_{bat} state of the FTU battery. The weight is 15 points; (1) when U_{bat}>=26V, 15 points; (2) when U_{bat}<21V, 0 point; (3) when 21V<=U_{bat}<26V, reducing by 3 points every reduction of 1V; and the voltage condition indicator of the FTU battery is M6.

In an embodiment, the condition indicators of the post-mounted vacuum switch include the switch opening time condition indicator.

The process of obtaining the scores of the condition indicators of the post-mounted vacuum switch includes the following steps.

The switch opening time of the post-mounted vacuum switch is acquired.

The switch opening time of the post-mounted vacuum switch is analyzed according to a seventh preset analysis rule to obtain the score of the switch opening time condition indicator.

The seventh preset analysis rule is as follows. The weight is a sixth preset value. When the switch opening time is less than 30 ms, the score of the switch opening time condition indicator is the sixth preset value. When the switch opening time is greater than 30 ms and less than 50 ms or when the switch opening time is equal to 30 ms, the score of the switch opening time condition indicator is a fifth score value. When the switch opening time is greater than 50 ms and less than 100 ms or when the switch opening time is equal to 50 ms, the score of the switch opening time condition indicator is a sixth score value. When the switch opening time is greater than or equal to 100 ms, the score of the switch opening time condition indicator is 0. The fifth score value is less than the sixth preset value, and the sixth score value is less than the fifth score value.

That is, in an embodiment, the scoring method for the switch opening time condition indicator is as follows.

The switch performance is evaluated based on the switch opening time T, and the weight is 10 points. (1) when T<30 ms, 10 points; (2) when 30 ms<=T<50 ms, 6 points; (3) when 50 ms<=T<100 ms, 2 points; (4)T>=100 ms, 0 point. The score of the opening and closing time condition indicator is M7.

In an embodiment, the condition indicators of the post-mounted vacuum switch includes a bonus value and a deduction value;

The score of the condition indicator of the post-mounted vacuum switch is a result of subtraction operation with the deduction value on the basis of the bonus value.

In an embodiment, the bonus value is used for addition operation of the scores of at least one of the following condition indicators: the score of the condition indicator of the lightning parameter, the score of the temperature condition indicator of the FTU battery, the score of the communication condition indicator, the score of the condition indicator of the transformer, the score of the switch opening and closing condition indicator, the score of the voltage condition indicator of the FTU battery, or the score of the switch opening time condition indicator.

The deduction value comprises at least one of: the score of the switch on-off characteristic condition indicator, the score of the switch refuse operation condition indicator, or the score of the switch maloperation condition indicator.

In an embodiment, the condition indicator of the post-mounted vacuum switch is the switch on-off characteristic condition indicator; and the process of obtaining the scores of the condition indicators of the post-mounted vacuum switch includes the following steps.

The number of opening-closing failures of a circuit breaker and a fault current are acquired.

The number of opening-closing failures and the fault current are analyzed according to an eighth preset analysis rule to obtain the score of the switch on-off characteristic condition indicator.

The eighth preset analysis rule is as follows. When the fault current is greater than OA and less than 5000A, the score of the switch on-off characteristic condition indicator is acquired by reducing the bonus value by a third preset deduction value. When the fault current is greater than 5000A and less than 10000A or when the fault current is equal to 5000A, the score of the switch on-off characteristic condition indicator is acquired reducing the bonus value by a fourth preset deduction value. When the fault current is greater than 10000A and less than 16000A or when the fault current is equal to 10000A, the score of the switch on-off characteristic condition indicator is acquired by reducing the bonus value by a fifth preset deduction value. When the fault current is greater than or equal to 16000A and the number of the opening-closing failures of the circuit breaker is less than 30, the score of the switch on-off characteristic condition indicator is acquired reducing the bonus value by a sixth preset deduction value. When the cumulative number of times the fault current being more than 10000A is more than 30, the score of the switch on-off characteristic condition indicator is acquired reducing the bonus value by a seventh preset deduction value.

In an embodiment, the third preset deduction value is a product of the number of on-off failures of the circuit breaker and 0.004, the fourth preset deduction value is a product of the number of on-off failures of the circuit breaker and 0.04, the fifth preset deduction value is a product of the number of on-off failures of the circuit breaker and 0.4, the sixth preset deduction value is a product of the number of on-off failures of the circuit breaker and 2, and the seventh preset deduction value is 40.

That is, in an embodiment, the scoring method for the switch breaking characteristic condition indicator is as follows.

The method is based on the number N of opening-closing failures of the circuit breaker and the fault current E, and adopts a point deducting scheme. (1) when 0<E<5000A, 1/10000*N*40 point is deducted; (2) when 5000A<=E<10000A, 1/1000*N*40 point is deducted; (3) when 10000A<=E<16000A, 1/100*N*40 point is deducted; (4) whenE>=16000A and N<30, 1/20*N*40 point is deducted; (5) when the accumulative number N of timesE>=10000A is greater than 30, 40 points are deducted. The switch on-off characteristic condition indicator is M8.

In an embodiment, the condition indicators of the post-mounted vacuum switch include the switch refuse operation condition indicator.

The process of obtaining the scores of the condition indicators of the post-mounted vacuum switch includes the following steps.

The number of switch refuse operations of the post-mounted vacuum switch is counted.

The number of switch refuse operations is analyzed according to a ninth preset analysis rule to obtain the score of the switch refuse operation condition indicator.

The ninth preset analysis rule is as follows. Every time the switch refuse operation occurs, the score of the switch refuse operation condition indicator is reduced by an eighth preset deduction value on the basis of the bonus value. If the number of switch refuse operations exceeds a preset switch refuse operation number within a first preset time range, the score of the switch refuse operation condition indicator is reduced by a ninth preset deduction value on the basis of the bonus value.

That is, in an embodiment, the scoring method for the switch refuse operation condition indicator includes the following steps.

The number of switch refuse operations of the equipment is counted and the point deducting scheme is adopted. When a sequence of events (SOE) is uploaded, if the SOE includes information such as the number of accidents, protection actions and the like, but does not include corresponding opening SOE (namely no switch opening information), the switch refusing is determined and 10 points are deducted every time the switch refuse operation occurs. If the accumulated number of refuse operations in the same day exceeds 2, 40 points are deducted, and one critical defect is recorded. The score of the switch refuse operation condition indicator is M9. The information such as the number of accidents, the protection action and the like can be understood as alarm information.

In an embodiment, the condition indicators of the post-mounted vacuum switch include the switch maloperation condition indicator.

The process of obtaining the scores of the condition indicators of the post-mounted vacuum switch includes the following steps.

The number of switch maloperations of the post-mounted vacuum switch is counted.

The number of switch maloperations is analyzed according to a tenth preset analysis rule to obtain the score of the switch maloperation condition indicator.

The tenth preset analysis rule is as follows. Every time the switch maloperation occurs, the score of the switch maloperation condition indicator is reduced by a tenth preset deduction value on the basis of the bonus value. If the cumulative number of the switch maloperations within a second preset time range exceeds a preset switch maloperation number, the score of the switch maloperation condition indicator is reduced by an eleventh preset deduction value on the basis of the bonus value.

That is, in an embodiment, the scoring method for the switch maloperation condition indicator is as follows. The number of the switch misoperations of the equipment is counted and the point deducting scheme is adopted. When the switch uploads an opening SOE message, if there is no corresponding overcurrent protection or operation of the scheduling staff, the switch maloperation is determined, and 10 points are deducted every time the switch maloperation occurs. If the accumulated number of the switch maloperations in the same day exceeds 2, 40 points are deducted, and one critical defect is recorded. The final score of the switch maloperation condition indicator is M10.

In an embodiment, a method for obtaining the repair coefficient X_{f} includes:

According to predetermined defect levels or fault levels and predetermined repair status levels, a preset fault repair table is searched to obtain the repair coefficient.

In an embodiment, the condition indicators may further include an operating life, a maintenance condition indicator caused by defect or fault, and the repair coefficient is obtained through the operating life, and the maintenance condition indicator caused by defect or fault.

In an embodiment, the service life coefficient K_{T} and the repair coefficient X_{F} are introduced by taking the operation life and the number of fault maintenances of the equipment as factors. If a component with a fault or a defect is repaired as good as new, the fault or the defect can be considered to be basically eliminated, and the health condition of the component can be restored to a higher level. If the component is repaired as old as before, it is considered that the hidden danger of the fault or the defect is not completely eliminated, but the health condition is apparently better than the condition before being repaired, and the basic score M of the condition assessment of the device is moderately reduced.

In an embodiment, the predetermined defect levels or fault levels include: Lₑᵥ=0, indicating the defect or the fault is not serious, Lₑᵥ=1, indicating the defect or the fault is serious, and Lₑᵥ=2, indicating the defect or the fault is urgent.

The predetermined repair status levels include: XF=0, indicating that the defect or fault has been completely repaired, XF=1, indicating that the defect or fault has not been completely repaired, XF=2, indicating that the defect or fault has not been repaired.

The preset fault repair table includes:

Lₑᵥ=0, XF=0, X_{f}=0.99;

Lₑᵥ=0, XF=1, X_{f}=0.97;

Lₑᵥ=0, XF=2, X_{f}=0.95;

Lₑᵥ=1, XF=0, X_{f}=0.95;

Lₑᵥ=1, XF=1, X_{f}=0.93;

Lₑᵥ=1, XF=2, X_{f}=0.7;

Lₑᵥ=2, XF=0, X_{f}=0.95;

Lₑᵥ=1, XF=1, X_{f}=0.9;

Lₑᵥ=2, XF=2, X_{f}=0.5.

K_{T}=(100−0.5*Y)/100, and Y denotes the operating life; M₀ is a variation, and the basic point after fault repair is M₀=100*K_{T}*X_{f}.

In an embodiment, the condition indicators of the 10 kV post-mounted vacuum switch include: the condition indicator of the lightning parameter, the temperature condition indicator of the FTU battery, the communication condition indicator, the condition indicator of the transformer, the voltage condition indicator of the FTU battery, the switch opening and closing condition indicator, the switch opening time condition indicator, an on-off characteristic condition indicator, the switch refuse operation condition indicator, and the switch maloperation condition indicator.

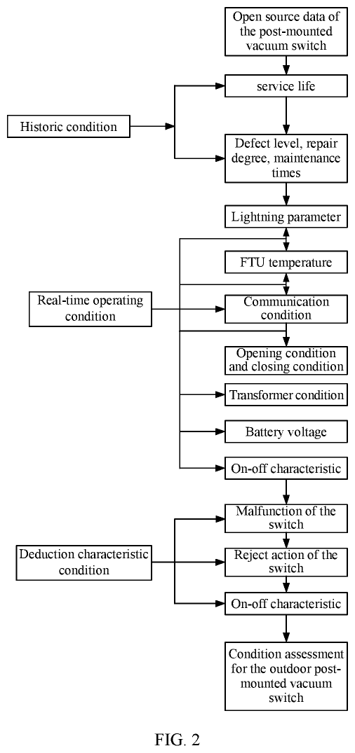

In an embodiment, FIG. 2 is a schematic diagram of another condition assessment method for the outdoor post-mounted vacuum switch according to an embodiment of the present disclosure. Referring to FIG. 2, a real-time operation condition includes: the condition indicator of the lightning parameter, the temperature condition indicator of the FTU battery, the communication condition indicator, the condition indicator of the transformer, the voltage condition indicator of the FTU battery, the switch opening and closing condition indicator, and the switch opening time condition indicator.

The point deducting scheme is applied to the switch on-off characteristic condition indicator, the switch refuse operation condition indicator and the switch maloperation condition indicator. In an embodiment, based on the above scores of the condition indicators, the operating condition of the device can be assessed and graded.

A first level is a normal condition, 85≤M≤100, the operating data of the device is stable, and all the electrical parameters are in accordance with the standard;

A second level is an attention condition, 75≤M<85 points. One main electrical parameter of the equipment approaches to a standard limit value or exceeds the attention value, or a plurality of auxiliary electrical parameters are not in accordance with the standard, but the operation of the equipment is not influenced.

A third level is an abnormal condition, 60≤M<75 points. Several main electrical parameters of the equipment exceed their standard limit values, or one main electrical parameter exceeds the standard limit value and several auxiliary electrical parameters are apparently abnormal. The performance index of the equipment is influenced or the abnormal condition may develop to a major abnormal condition, however, the equipment can still continue to operate.

A fourth level is a severe condition. M<60 points. One or more electrical parameters of the equipment are greatly out of standard or seriously abnormal, and the equipment can only be operated for a short time or immediately stopped.

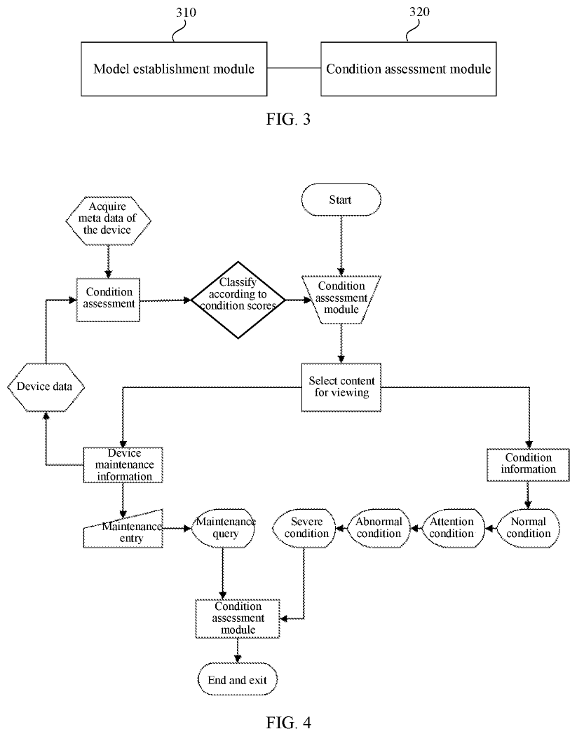

FIG. 3 is a schematic structural diagram of a condition assessment device of an outdoor post-mounted vacuum switch according to an embodiment of the present disclosure. Referring to FIG. 3, the embodiment of the disclosure provides a condition assessment device for an outdoor post-mounted vacuum switch. The device includes:

a model establishment module 310, configured to establish a condition assessment mathematical model for the post-mounted vacuum switch, and obtain scores of condition indicators of the post-mounted vacuum switch; and a condition assessment module 320, configured to acquire a condition assessment score based on the condition assessment mathematical model of the post-mounted vacuum switch according to the scores of the condition indicators of the post-mounted vacuum switch, so as to realize on-line monitoring of a health condition of the post-mounted vacuum switch and assess the health condition of the post-mounted vacuum switch.

The condition assessment mathematical model of the post-mounted vacuum switch is configured as follows:

$$M = {M}_{0} - {\sum }_{i = 1}^{10} {M}_{i} .$$

M denotes the condition assessment score. Mᵢ denotes the score of the ith condition indicator of the post-mounted vacuum switch, and M₀=100 K_{T}X_{f}. X_{f} denotes a repair coefficient, and a lifetime coefficient K_{T}=(100−0.5Y)/100. Y denotes a service life.

In an embodiment, the condition assessment device for the outdoor post-mounted vacuum switch provided by the embodiment of the present disclosure may execute the condition assessment method of the outdoor post-mounted vacuum switch provided by any one of the above-mentioned embodiments.

FIG. 4 is a flow chart of still another condition assessment method for the outdoor post-mounted vacuum switch according to an embodiment of the present disclosure. Various operating state data and historical maintenance record texts (caused by faults or defects) of the 10 kV post-mounted vacuum switch are automatically acquired via a data acquisition apparatus and classified according to condition scores, and then are inputted into a condition assessment model. The condition assessment model is used for scoring according to importance levels of the various condition indicators. The final score is determined according to the condition assessment mathematical model of the post-mounted vacuum switch, and assessment and grading are executed. According to the maintenance information of the apparatus (or equipment) provided by assessment and grading condition, the equipment maintenance is carried out. According to the operation state information provided by the assessment and grading condition, the operating state is adjusted and repaired in time, and then the condition assessment is carried out again.

According to the condition assessment method for the outdoor post-mounted vacuum switch, the condition indicators of the post-mounted vacuum switch can be on-line obtained from related equipment without increasing the cost. Factors such as the defect repair coefficient and service life coefficient are considered, and the condition assessment model is more suitable for actual operation and maintenance conditions. There are following advantages compared with the related art.

1. the data of the equipment is automatically acquired, the labor intensity of workers is reduced, and the working efficiency is improved.

2. the condition indicators of the primary electrical equipment and the secondary electrical equipment are comprehensively analyzed, the use condition of the equipment are reasonably and scientifically analyzed, and the operation state of the equipment is accurately acquired.

3. equipment conditions are classified through information fusion and visualization technologies, and basic information of the equipment, multiple parameter conditions and condition scores are displayed rapidly and clearly.

4. multiple types of conditions of the equipment are analyzed, integrated and counted by a data mining technology.

5. the multiple types of parameter conditions of the equipment are updated in real time, and the operation state of the equipment is accurately and timely reflected.

The embodiment of the present disclosure can carry out on-line monitoring on outdoor post-mounted vacuum switches of 10 kV, 35 kV or the like, and established a multi-dimensional outdoor post-mounted vacuum switch assessment system by deep analysis on uploaded mass data, so that on-line condition grading of the post-mounted vacuum switch and corresponding fault emergency repair strategies can be efficiently carried out. Therefore, the operation reliability and the operation life of equipment are improved, and the power failure time is reduced.

1. A condition assessment method for an outdoor post-mounted vacuum switch, comprising:
establishing a condition assessment mathematical model for the post-mounted vacuum switch, and obtaining scores of condition indicators of the post-mounted vacuum switch; and
acquiring a condition assessment score according to the scores of the condition indicators of the post-mounted vacuum switch and the condition assessment mathematical model of the post-mounted vacuum switch, so as to realize on-line monitoring of a health condition of the post-mounted vacuum switch and assess the health condition of the post-mounted vacuum switch;
wherein the condition assessment mathematical model of the post-mounted vacuum switch is:
$$M = {M}_{0} - {\sum }_{i = 1}^{10} {M}_{i} ,$$
wherein the M is the condition assessment score; Mᵢ denotes the score of the ith condition indicator of the post-mounted vacuum switch; and M₀=100 K_{T}X_{f}, X_{f} denotes a repair coefficient, and a lifetime coefficient K_{T}=(100−0.5Y)/100, wherein the Y denotes a service life.

2. The method of claim 1, wherein the condition indicators of the post-mounted vacuum switch comprise at least one of:
a condition indicator of a lightning parameter, a temperature condition indicator of a feeder terminal unit (FTU) battery, a communication condition indicator, a condition indicator of a transformer, a voltage condition indicator of the FTU battery, a switch opening and closing condition indicator, a switch opening time condition indicator, an on-off characteristic condition indicator, a switch refuse operation condition indicator, or a switch maloperation condition indicator.

3. The method of claim 2, wherein the condition indicators of the post-mounted vacuum switch comprises the condition indicator of the lightning parameter;
wherein the obtaining the scores of the condition indicators of the post-mounted vacuum switch comprises:
collecting an amplitude I of a lightning current at a tower, a distance S between a lightning strike point and the tower, and a height h_{c} of the tower of the post-mounted vacuum switch through lightning location, and calculating a direct lightning stroke
$${U}_{0} = 25 I \frac{{h}_{c}}{S}$$
or a lightning induced overvoltage
$${U}_{0} = 25 I [ \frac{{h}_{c}}{S} + \sqrt{{( \frac{{h}_{c}}{S} )}^{2} + 1} ] ;$$
and
analyzing the value of U₀ according to a first preset analysis rule to obtain the score of the condition indicator of the lightning parameter;
wherein the first preset analysis rule comprises: a weight being a first preset value; when the U₀ is less than or equal to 85 kV, the score of the condition indicator of the lightning parameter being the first preset value; when the U₀ is greater than 85 kV and less than 140 kV or the U₀ is equal to 140 kV, the score of the condition indicator of the lightning parameter being a first score value, and the first score value being less than the first preset value; and when the U₀ is greater than 140 kV, the score of the condition indicator of the lightning parameter being reducing the first score value by a first preset deduction value every increment 1 kV of the U₀ on the basis of 140 kV.

4. The method of claim 2, wherein the condition indicators of the post-mounted vacuum switch comprise the condition indicator of a temperature of the FTU battery;
wherein the obtaining the score of the condition indicators of the post-mounted vacuum switch comprises:
collecting an internal temperature value of the FTU battery in real time; and, analyzing the internal temperature value of the FTU battery according to a second preset analysis rule to obtain the score of the temperature condition indicator of the FTU battery;
wherein the second preset analysis rule comprises: a weight being a second preset value; when the internal temperature value of the FTU battery is greater than −25.0° C. and less than 55.0° C., the score of the temperature condition indicator of the FTU battery being the second preset value; when the internal temperature value of the FTU battery is greater than 55.1° C. and less than 64.9° C. or when the internal temperature value of the FTU battery is greater than −34.9° C. and less than −25.1° C., the score of the temperature condition indicator of the FTU battery being a second score value; when the internal temperature value of the FTU battery is greater than 65° C. and less than 69.999° C. or when the internal temperature value of the FTU battery is greater than −39.9° C. and less than −35.1° C., the score of the temperature condition indicator of the FTU battery being a third score value; and when the internal temperature value of the FTU battery is greater than or equal to 70° C. or when the internal temperature value of the FTU battery is less than or equal to −40° C., the score of the temperature condition indicator of the FTU battery is zero; wherein the second score value is less than the second preset value, and the third score value is less than the second score value.

5. The method of claim 2, wherein the condition indicators of the post-mounted vacuum switch comprise the voltage condition indicator of the FTU battery;
wherein the obtaining the scores of the condition indicators of the post-mounted vacuum switch comprises:
acquiring a real voltage U_{bat} of the FTU battery; and
analyzing the value of U_{bat} according to a third preset analysis rule to obtain the score of the voltage condition indicator of the FTU battery;
wherein the third preset analysis rule comprises: a weight being a third preset value; when the U_{bat} is greater than or equal to 26V, the score of the voltage condition indicator of the FTU battery being the third preset value; when the U_{bat} is less than 21V, the score of the voltage condition indicator of the FTU battery is 0; and when the U_{bat} is greater than 21 V and less than 26V or when the U_{bat} is equal to 21V, the score of the voltage condition indicator of the FTU battery is reducing the third preset value by a second preset deduction value every decrement 1V of the U_{bat} on the basis of the third preset value.

6. The method of claim 2, wherein the condition indicators of the post-mounted vacuum switch comprise the communication condition indicator;
wherein the obtaining the scores of the condition indicators of the post-mounted vacuum switch comprises:
acquiring a time of the post-mounted vacuum switch; and
analyzing the time according to a fourth preset analysis rule to obtain the score of the communication condition indicator;
wherein the fourth preset analysis rule comprises: a weight being a fourth preset value; when an absolute value of a difference between a time of a server and the time of the post-mounted vacuum switch is less than a preset time threshold value, confirming that the post-mounted vacuum switch is in normal communication and the score of the communication condition indicator is the fourth preset value; and when the absolute value of the difference between the time of the server and the time of the post-mounted vacuum switch is not less than the preset time threshold value, confirming that the post-mounted vacuum switch is in abnormal communication and the score of the communication condition indicator is 0.

7. The method of claim 2, wherein the condition indicators of the post-mounted vacuum switch comprise the condition indicator of the transformer; wherein the obtaining the scores of the condition indicators of the post-mounted vacuum switch comprises:
acquiring a voltage value and a tri-phase unbalance factor of a current; and
respectively analyzing the voltage value and the tri-phase unbalance factor of the current according to a fifth preset analysis rule to obtain the score of the condition indicator of the transformer;
wherein the fifth preset analysis rule comprises: when the tri-phase unbalance factor of the current is less than a preset percentage, a first part score of the condition indicator of the transformer being a fourth score value; when the tri-phase unbalance factor of the current is not less than the preset percentage, the first part score of the condition indicator of the transformer is 0; in the case of not being grounded, when the voltage value is greater than 5.5 kV and less than 6.5 kV or when the voltage value is equal to 5.5 kV or when the voltage value is equal to 6.5 kV, a second part score of the condition indicator of the transformer being the fourth score value; in the case of not being grounded, when the voltage value is less than 5.5 kV or greater than 6.5 kV, the second part score of the condition indicator of the transformer is 0; wherein the score of the condition indicator of the transformer titer being a sum of the first part score of the condition indicator of the transformer and the second part score of the condition indicator of the transformer.

8. The method of claim 2, wherein the condition indicators of the post-mounted vacuum switch comprise the switch opening and closing condition indicator;
wherein the obtaining the scores of the condition indicators of the post-mounted vacuum switch comprises:
determining whether the post-mounted vacuum switch is in an opening state or a closing state, and acquiring a current value in the opening state or the closing state; and
analyzing according to a sixth preset analysis rule in conjunction with the opening state of the post-mounted vacuum switch or the closing state of the post-mounted vacuum switch and the current value to obtain the score of the switch opening and closing condition indicator;
wherein the sixth preset analysis rule comprises: a weight being a fifth preset value; when the post-mounted vacuum switch is in the opening state and the current value is less than 3A, the score of the switch opening and closing condition indicator being the fifth preset value; when the post-mounted vacuum switch is in the opening state and the current value is not less than 3A, the score of the switch opening and closing condition indicator being 0; when the post-mounted vacuum switch is in the closing state and the current value is greater than 3A, the score of the switch opening and closing condition indicator being the fifth preset value; and when the post-mounted vacuum switch is in the closing state and the current value is not greater than 3A, the score of the switch opening and closing condition indicator being 0.

9. The method of claim 2, wherein the condition indicators of the post-mounted vacuum switch comprise the switch opening time condition indicator; wherein the obtaining the scores of the condition indicators of the post-mounted vacuum switch comprises:
acquiring a switch opening time of the post-mounted vacuum switch; and
analyzing the switch opening time of the post-mounted vacuum switch according to a seventh preset analysis rule to obtain the score of the switch opening time condition indicator;
wherein the seventh preset analysis rule comprises: a weight being a sixth preset value; when the switch opening time is less than 30 ms, the score of the switch opening time condition indicator being the sixth preset value; when the switch opening time is more than 30 ms and less than 50 ms or when the switch opening time is equal to 30 ms, the score of the switch opening time condition indicator being a fifth score value; when the switch opening time is greater than 50 ms and less than 100 ms or when the switch opening time is equal to 50 ms, the score of the switch opening time condition indicator being a sixth score value; and when the switch opening time is greater than or equal to 100 ms, the score of the switch opening time condition indicator being 0; wherein the fifth score value is less than the sixth preset value, and the sixth score value is less than the fifth score value.

10. The method of claim 2, wherein the scores of the condition indicators of the post-mounted vacuum switch comprise a bonus value and a deduction value;
and wherein the score of the condition indicator of the post-mounted vacuum switch is a result of subtraction operation with the deduction value on the basis of the bonus value.

11. The method of claim 10, wherein the bonus value is used for addition operation of the scores of at least one of the following condition indicators: the score of the condition indicator of the lightning parameter, the score of the temperature condition indicator of the FTU battery, the score of the communication condition indicator, the score of the condition indicator of the transformer, the score of the switch opening and closing condition indicator, the score of the voltage condition indicator of the FTU battery, or the score of the switch opening time condition indicator;
the deduction value comprises at least one of: the score of the switch on-off characteristic condition indicator, the score of the switch refuse operation condition indicator, or the score of the switch maloperation condition indicator.

12. The method of claim 11, wherein the condition indicators of the post-mounted vacuum switch comprise the switch on-off characteristic condition indicator; and the obtaining the scores of the condition indicators of the post-mounted vacuum switch comprising:
acquiring a number of opening-closing failures of a circuit breaker and a fault current; and
analyzing the opening-closing failure times and the fault current according to an eighth preset analysis rule to obtain the score of the switch on-off characteristic condition indicator;
wherein the eighth preset analysis rule comprises: when the fault current is greater than OA and less than 5000A, the score of the switch on-off characteristic condition indicator being reducing the bonus value by a third preset deduction value; when the fault current is greater than 5000A and less than 10000A or when the fault current is equal to 5000A, the score of the switch on-off characteristic condition indicator being reducing the bonus value by a fourth preset deduction value; when the fault current is greater than 10000A and less than 16000A or when the fault current is equal to 10000A, the score of the switch on-off characteristic condition indicator being reducing the bonus value by a fifth preset deduction value; when the fault current is greater than or equal to 16000A and the number of the opening-closing failures of the circuit breaker is less than 30, the score of the switch on-off characteristic condition indicator being reducing the bonus value by a sixth preset deduction value; and when the cumulative number of times the fault current being more than 10000A is more than 30, the score of the switch on-off characteristic condition indicator being reducing the bonus value by a seventh preset deduction value.

13. The method of claim 12, wherein the third preset deduction value is a product of the number of on-off failures of the circuit breaker and 0.004, the fourth preset deduction value is a product of the number of on-off failures of the circuit breaker and 0.04, the fifth preset deduction value is a product of the number of on-off failures of the circuit breaker and 0.4, the sixth preset deduction value is a product of the number of on-off failures of the circuit breaker and 2; and the seventh preset deduction value is 40.

14. The method of claim 11, wherein the condition indicators of the post-mounted vacuum switch comprise the switch refuse operation condition indicator;
wherein the obtaining the scores of the condition indicators of the post-mounted vacuum switch comprises:
counting a number of switch refuse operations of the post-mounted vacuum switch; and
analyzing the number of switch refuse operations according to a ninth preset analysis rule to obtain the score of the refuse operation condition indicator;
wherein the ninth preset analysis rule comprises: every time the switch refuse operation occurs, the score of the switch refuse operation condition indicator being reduced by an eighth preset deduction value on the basis of the bonus value; if the number of switch refuse operations exceeds a preset switch refuse operation number within a first preset time range, the score of the switch refuse operation condition indicator is reduced by a ninth preset deduction value on the basis of the bonus value.

15. The method of claim 11, wherein the condition indicators of the post-mounted vacuum switch comprise the switch maloperation condition indicator; wherein the obtaining the scores of the condition indicators of the post-mounted vacuum switch comprises:
counting a number of switch maloperations of the post-mounted vacuum switch; and
analyzing the number of switch maloperations according to a tenth preset analysis rule to obtain the score of the switch maloperation condition indicator;
wherein the tenth preset analysis rule comprises: every time the switch maloperation occurs, the score of the switch maloperation condition indicator being reduced by a tenth preset deduction value on the basis of the bonus value; if the cumulative number of the switch maloperations exceeds a preset switch maloperation number within a second preset time range, the score of the switch maloperation condition indicator being reduced by an eleventh preset deduction value on the basis of the bonus value.

16. The method according to claim 1, wherein the method for obtaining the repair coefficient X_{f} comprises:
according to predetermined defect levels or fault levels and predetermined repair status levels, searching a preset fault repair table to obtain the repair coefficient.

17. The method of claim 16, wherein the predetermined defect levels or fault levels comprise: Lₑᵥ=0, indicating the defect or the fault is not serious, Lₑᵥ=1, indicating the defect or the fault is serious, and Lₑᵥ=2, indicating the defect or the fault is urgent;
the predetermined repair status levels comprise: XF=0, indicating that the defect or fault has been completely repaired, XF=1, indicating that the defect or fault has not been completely repaired, XF=2, indicating that the defect or fault has not been repaired;
the preset fault repair table comprises:
Lₑᵥ=0, XF=0, X_{f}=0.99;
Lₑᵥ=0, XF=1, X_{f}=0.97;
Lₑᵥ=0, XF=2, X_{f}=0.95;
Lₑᵥ=1, XF=0, X_{f}=0.95;
Lₑᵥ=1, XF=1, X_{f}=0.93;
Lₑᵥ=1, XF=2, X_{f}=0.7;
Lₑᵥ=2, XF=0, X_{f}=0.95;
Lₑᵥ=2, XF=1, X_{f}=0.9;
Lₑᵥ=2, XF=2, X_{f}=0.5.

18. A condition assessment device for an outdoor post-mounted vacuum switch, comprising:
a model establishment module, configured to establish a condition assessment mathematical model of the post-mounted vacuum switch, and obtain scores of condition indicators of the post-mounted vacuum switch; and
a condition assessment module, configured to acquire a condition assessment score based on the condition assessment mathematical model of the post-mounted vacuum switch and the scores of the condition indicators of the post-mounted vacuum switch, so as to realize on-line monitoring of a health condition of the post-mounted vacuum switch and assess the health condition of the post-mounted vacuum switch;
wherein the condition assessment mathematical model of the on-column vacuum switch is configured as follows:
$$M = {M}_{0} - {\sum }_{i = 1}^{10} {M}_{i}$$
wherein the M is the condition assessment score; Mᵢ denotes the score of the ith condition indicator of the post-mounted vacuum switch; and M₀=100 K_{T}X_{f}, X_{f} denotes a repair coefficient, and a lifetime coefficient K_{T}=(100−0.5Y)/100, wherein the Y denotes a service life.
